(19) United States
(12) Patent Application Publication
(10) Pub. No.: US 2008/0193100 A1
(43) Pub. Date: Aug. 14, 2008

(54) Methods and apparatus for processing edits to online video

(76) Inventors: Geoffrey King Baum, Palo Alto, CA (US); Lalit Balchandani, San Francisco, CA (US); Daniel Hai, San Francisco, CA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 11/706,040

(22) Filed: Feb. 12, 2007

(51) Int. Cl. G11B 27/00

(52) U.S. Cl. 386/52

(57) ABSTRACT

An online media player provides mechanisms and techniques that allow for real-time edit decision list execution on streaming video to play back an edited video in an online environment. The online media player can request a digital media presentation from at least one server. The online media player can receive an edit decision list and a media effects set from the server, where the edit decision list is associated with the digital media presentation. The online media player can receive streaming media base data, associated with the digital media presentation, from a server. The client applies the edit decision list and upon the streaming media base data in real-time to create the digital media presentation. No file for the complete digital media presentation is fully-rendered and saved prior to play back.

### BACKGROUND

Conventional desktop software applications operate on computer systems to allow for users, known as film or video editors, to edit digital video content. In particular, non-linear editing is a non-destructive editing method that involves being able to access any frame in a video clip with the same ease as any other. Initially, video and audio data from a media source file can be digitized and recorded directly to a storage device that is local to the computer system, like a desktop personal computer. The media source file can then be edited on the computer using any of a wide range of video editing software. Example edits that can be made to the video include splicing video segments together, applying effects to video, adding subtitles, and the like.

### SUMMARY

In conventional non-linear editing, the media source file is not lost or modified during editing. Instead, during the edit process, the conventional desktop software records the decisions of the film editor to create an Edit Decision List. An Edit Decision List is a way of representing a video edit. It can contain an ordered list of reel and timecode data representing how to manipulate the locally stored media source file in order to properly render the edited video. In other words, the Edit Decision List can describe the editing steps the conventional desktop software application must perform on the locally stored media source file in order to completely generate and store a complete full version of the edited video file prior to playing the edited video. Many generations and variations of the locally stored media source file can exist in storage by creating and storing different Edit Decisions Lists. An Edit Decision List also makes it easy to change, delete and undo previous decisions simply by changing parts of the Edit Decision List. Compared to the linear method of tape-to-tape editing, non-linear editing offers the flexibility of film editing coupled with random access and easy project organization.

Conventional techniques for non-linear editing suffer from a variety of deficiencies In particular, conventional techniques that provide non-linear editing incur rendering and processing costs associated with rendering the edited video file via executing the Edit Decision List upon the locally stored media source file to produce a new edited version of the video. In addition, file storage costs are also incurred as such conventional techniques do not operate in a hosted or online (e.g. networked) environment but are rather desktop applications that edit local video sources. That is, the media source file, the file for the fully-rendered edited video and the Edit Decision List must all reside on the same desktop computer system. Another deficiency involves sharing the fully-rendered edited video. In conventional systems, the film editor must completely render an entire edited video file before sharing it with an associate. If the video editor wants to preview a number of edit options for a single media source file, then he is required to fully render and share an edited video file for each option. That is, using conventional edit decision lists, to watch or render the edited video, the video editing software first produces and stores a secondary copy of the original video that includes the edits from the edit decision list. This secondary copy is then played for the viewing user. One problem with this is that the secondary copy consumes significant storage.

Embodiments disclosed herein significantly overcome such deficiencies and provide mechanisms and techniques that allow for real-time edit decision list execution on streaming video to play back an edited video in an online environment without having to produce and store (for playback) a full version of the edited video. In particular, such embodiments can be implemented without requiring creation of a fully-rendered (or renderable) file of the edited video. Additionally, the system disclosed herein operates over a network to allow a user to create an edit decision list that defines and describes edits to be made to an original or source set of video(s). The edit decision list can then be shared with others via a network server such as a web server, and no version of the edited video needs to be stored. For example, upon request, a client can receive (i.e. can request and obtain) an edit decision list from a server system, that is related to a digital media presentation. The edit decision list can be an XML-based text file that contains instructions and information for a client and server as to video edits, video sequencing, file layering and audio data that can be applied to media base data (i.e. the original video) to ultimately present an edited version of the original video to the user. The system never needs to persistently store the edited version (the digital media presentation), but only needs to have the original unedited video, and the edit decision list that indicates what edits are to be made, in real-time, to the original video to reproduce the edited version during real time application of the edit decision list to the original video. The digital media presentation thus represents application of the edit decision list to parts of media base data that are rendered in real-time and thus never exists in its complete form in persistent storage. The edit decision list can be a hyperlink or include many hyperlinks to resources (e.g. such as video clips, editing effects, and the like) that reside on a network such as the Internet. In addition to the edit decision list, the user can also receive a media effects set that can include effects, graphics and transitions that can be applied to the media base data. Both the edit decision list and media effects set can be forwarded to the user via application programming interfaces that operate between a client such as a web browser equipped with an editing and video playback process and the server.

The edit decision list can be interprested by the client or can be sent to the server to instruct the server to stream media base data to the client-user. The media base data can be an aggregate of individual video, audio, and graphics files stitched together into a continuous video as defined by the edits encoded into the edit decision list. Such files can each reside at universal resource locators (U.R.L). within an asset management system (e.g., digital library) related to the server or even throughout many different computer systems on the Internet. Hence, the edit decision list can instruct the server to locate and to collect video, audio, and graphics files and to further sequence and layer the files accordingly.

As the media base data, such as a stitched continuous video, gets streamed to the client-user, it is received and processed at a player local to the client in order to present the video in an edited version. However, no actual file of this edited version is required to be fully rendered, constructed and saved at the client. Instead, both the edit decision list and media effects set are executed in real-time upon the streaming media base data. The media base data is thus the original video and the client player obtains the edit decision list and “executes” the edit instructions contained therein upon the media base data. Segments of the edit decision list may be sent to the server of the media base data and the server can determine the order at which to serve which segments of the media base data. Therefore, performance, storage and rendering costs are substantially lowered because the edited video is presented by executing the edit decision list and media effects set with the streaming media base data. Because such execution occurs in real-time, there is no requirement to transcode the edited video at the end of an editing session and to store files (i.e. a single new edited file) that are edited versions of the media base data.

More specifically, embodiments disclosed herein provide for an online media player that can request a digital media presentation from at least one server. A client can receive an edit decision list and a media effects set from the server, where the edit decision list and the media effects set (e.g. media effects) are associated with the digital media presentation. The online media player allows for the server to stream media base data, associated with the digital media presentation, from the server to the client. The client executes the edit decision list and the media effects set upon the streaming media base data in real-time to play the digital media presentation. Hence, the edit decision list can instruct both the client and server to perform appropriate edits at certain times upon the media base data as it is streaming.

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein. Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Adobe Systems Incorporated of San Jose, Calif., U.S.A., herein after referred to as “Adobe” and “Adobe Systems.”

### BRIEF DESCRIPTION OF THE DRAWINGS

The foregoing and other objects, features and advantages of the invention will be apparent from the following more particular description of embodiments of the methods and apparatus for executing an edit decision list and a media effects set on streaming media base data, as illustrated in the accompanying drawings and figures in which like reference characters refer to the same parts throughout the different views. The drawings are not necessarily to scale, with emphasis instead being placed upon illustrating the embodiments, principles and concepts of the methods and apparatus in accordance with the invention.

FIG. 1 is a block diagram of a computerized system configured with an application including an online media player in accordance with one embodiment of the invention.

FIG. 2 is another block diagram of an online media player implemented via a computer network system in accordance with one embodiment of the invention.

FIG. 3 is a flow chart of processing steps that show high-level processing operations performed by an online media player to execute an edit decision list and a media effects set upon streaming media base data in real-time to play a digital media presentation.

FIG. 4 is a flow chart of processing steps that show high-level processing operations performed by an online media player to receive an edit decision list from a server.

FIG. 5 is a flow chart of processing steps that show high-level processing operations performed by an online media player to receive a media effects set from a server.

FIG. 6 is a flow chart of processing steps that show high-level processing operations performed by an online media player to stream media base data from a server.

FIG. 7 is a flow chart of processing steps that show high-level processing operations performed by an online media player to aggregate at least one of a video base file, a image base file and an audio base file.

FIG. 8 is a flow chart of processing steps that show high-level processing operations performed by an online media player to request a digital media presentation from a server.

### DETAILED DESCRIPTION

Embodiments disclosed herein include methods, software and a computer system that provides an online rich media player, such as a Flash Player for example, that allows for real-time execution or application of an edit decision list on streaming video to play back an edited version of the original video in an online environment without requiring storage of the edited version. The system disclosed herein can be utilized within a rich media player and server such as a Flash Player and Flash Media Sever which are software products made by Adobe Systems Incorporated of San Jose, Calif., USA. Using the system disclosed herein, when original video content (referred to herein as media base data) is edited, enhanced or remixed, such edits don't modify the media base data. Instead, all edits or changes made are be saved in an XML-based text file as an edit decision list that is associated with the media base data used in the editing session. After the edit decision list has been saved, an online user can operate the client (e.g. rich media player) to request the edited version of the video. As an example, the user may operate a web browser equipped with a rich media player plugin, such as a Flash plugin. When visiting a web site containing video content, the user may select a video for playback within that user's browser via the Flash player.

Upon such a request, instead of obtaining an edited verison of video, the rich media player requests and can receive the edit decision list from a server system operating a rich media server (such as the Flash media server). The edit decision list is related to a digital media presentation (i.e. the requested video along with the edits applied). The edit decision list contains instructions and information for a client (e.g. Flash player) and server (e.g. Flash media server) as to video edits, video sequencing, file layering and audio data that can be applied to media base data (e.g. original unedited video) in order to ultimately present an edited presentation of the original video to the user. The edit decision list can include many hyperlinks to media resources (e.g. media server and specific media bases data) that reside on a network such as the Internet. In addition to the edit decision list, the client's rich media player can also receive a media effects set that can include effects, graphics and transitions that can be applied to the media base data. Both the edit decision list and media effects set can be requested and received by the client (e.g. flash player or other rich media player) via application programming interfaces related to the server. In some embodiments, once the client has received the edit decision list, portions of the edit decision list may be sent to the server to allow the server to assemble and stream the base media data back to the client.

The edit decision list can thus instruct the server to stream media base data to the client. The media base data can be an aggregate of individual video, audio, and graphics files stitched together into a continuous video. Such files can each reside at universal resource locators (U.R.L). within an asset management system (e.g., digital library) accessible by the server throughout the Internet. Hence, the edit decision list can instruct the server to locate, collect and stream video, audio, and graphics files and to further sequence and layer the files accordingly.

As the media base data, such as a stitched continuous video, gets streamed to the client-user, it is received and processed at a rich media player local to the client in order to present the video in an edited version. However, no actual file of this edited version is required to be fully rendered and saved at the client or server. Instead, both the edit decision list and media effects set are executed or applied in real-time upon the streaming media base data. Therefore, performance, storage and rendering costs are substantially lowered because the edited video is presented by combining the edit decision list and media effects set with the streaming media base data. Since this occurs in real-time, there is no requirement to transcode the edited video at the end of an editing session and to store files that are edited versions of the media base data.

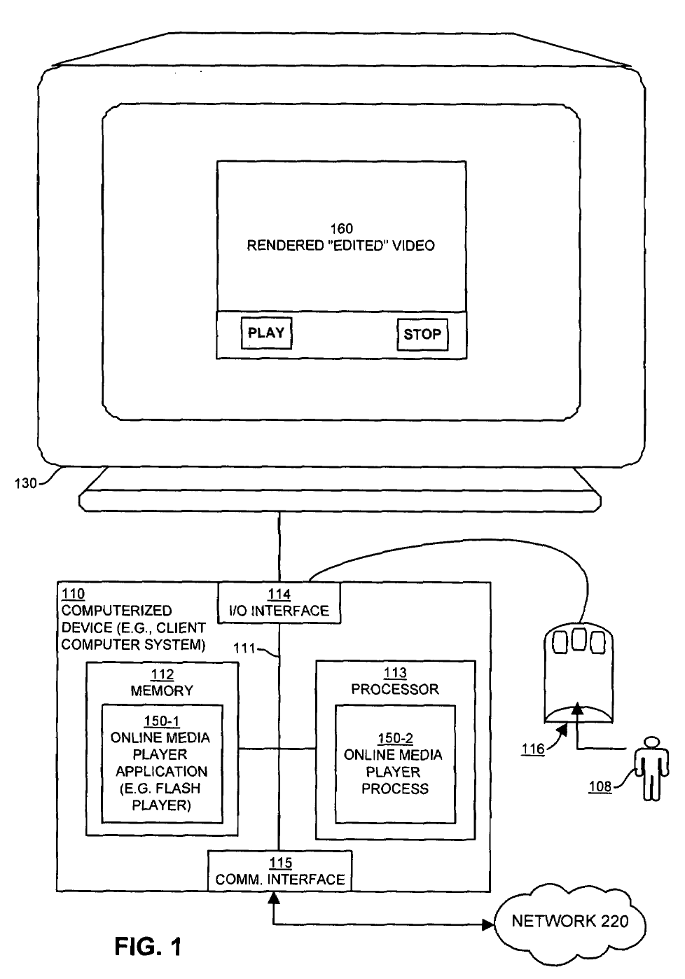

FIG. 1 is a block diagram illustrating example architecture of a computer system 110 that executes, runs, interprets, operates or otherwise performs a online media player application 150-1 (e.g., a rich media player such as a Flash Player) and online media player process 150-2 (e.g. an executing version of the application 150-1 controlled by user 108) configured in accordance with embodiments of the invention to produce, in real-time, a rendered edited video 160. The computer system 110 may be any type of computerized device such as a personal computer, workstation, portable computing device, console, laptop, network terminal or the like. As shown in this example, the computer system 110 includes an interconnection mechanism 111 such as a data bus, motherboard or other circuitry that couples a memory system 112, a processor 113, an input/output interface 114, and a communications interface 115 that can interact with a network 220 to receive streaming media data from a server that can also implement aspects of the online rich media player application 150-1 and process 150-2. An input device 116 (e.g., one or more user/developer controlled devices such as a keyboard, mouse, touch pad, etc.) couples to the computer system 110 and processor 113 through an input/output (I/O) interface 114.

The memory system 112 is any type of computer readable medium and in this example is encoded with an online media player application 150-1 that supports generation, display, and implementation of functional operations as explained herein. During operation of the computer system 110, the processor 113 accesses the memory system 112 via the interconnect 111 in order to launch, run, execute, interpret or otherwise perform the logic instructions of the online media player application 150-1. Execution of the online media player application 150-1 in this manner produces processing functionality in a online media player process 150-2. In other words, the process 150-2 represents one or more portions or runtime instances of the application 150-1 (or the entire application 150-1) performing or executing within or upon the processor 113 in the computerized device 110 at runtime.

Further details of configurations explained herein will now be provided with respect to flow charts of processing steps that show the high level operations disclosed herein to perform the online media player process 150-2, as well as graphical representations that illustrate implementations of the various configurations of the online media player process 150-2.

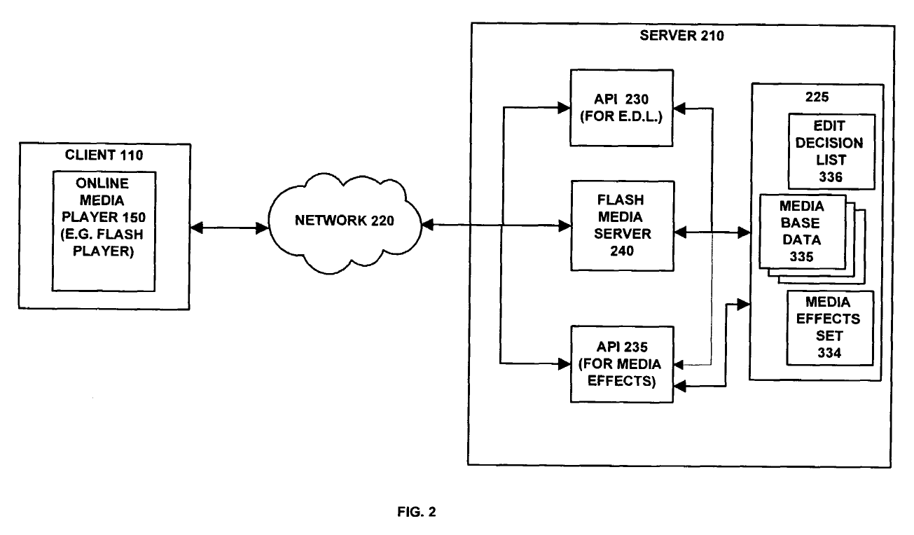

FIG. 2 is another block diagram of an online media player 150 such as a Flash Player or other rich media player (or video or other media player/editor combination) implemented via a computer network system in accordance with one embodiment of the invention. A user can utilize the online media player 150 to produce and play a digital media presentation. For example, the user can control the online media player 150 to access the server's asset management system 225 to select two individual video clips (e.g. base media data 335). Using the online media player 150, the user can sequence the two video clips into one continuous video. Further, the user can add an opening title screen with a transition to the initial frame of the edited video. Also, the user can add Spanish subtitles throughout the frames of the edited video wherever dialogue occurs. Other special effects can be inserted as well. For instance, a few video frames can be converted to ‘black-and-white,’ and some frames can be enhanced with audio effects.

As all such edits, effects, and enhancements are selected and applied, the online media player 150 creates an edit decision list 336 and a media effects set 334 that are stored by the server 210 within an asset management system 225. As an example, the edit decision list 336 can represent the sequencing of the two individual video clips 335 and the title screen. The edit decision list 336 can also include indications of where certain effects and enhancements need to occur. The media effects set 334 contains effects to create the text of the title, the Spanish subtitles, the audio effects, and the ‘black-and-white’ frame effects. The edit decision list and the media effects set can be stored at the server 210 and the asset management system 225 for future access and for sharing among other users. No actual file for the edited video is fully-rendered or stored prior to playing the edited video. The “edited” video is thus a combination of the edit decision list 336 and the available original base media data 335 that the client player 150 and rich media server 240 utilize to create, in real-time, an edited rendition of the original base media data (with edits) within the player 150. This edited version is never statically stored persistently.

The user can then share a link to the edited video (i.e. a link to the edit decision list 336) with the other users. Upon activating the link to the “edited video”, the server 210 can send the edit decision list 336 and the media effects set 334 (if required) to a second user operating another client via an application programming interface 230, 235 related to the server 210. The edit decision list can send instructions back to the server 210 to retrieve the two individual video clips previously used in the editing session. The server 210 searches the asset management system 225 for the particular video clips and begins streaming the two video clips, via a rich media server such as Flash Media Server 240, in a sequence according to instructions of the edit decision list. At the client computer 110, a Flash Player 150 interacts with (e.g. interprets) the edit decision list 336 and the media effects set as it receives the properly-sequenced video from the server 210 to apply edits and media effects in real-time to the incoming streaming video (base media data 335). Thus, it is understood that various processing of the online media player 150, such as the application 150-1 and process 150-2, can be distributed and implemented between the client 215 and the server 210. Further, the Flash Media Player 245 can also be part of a browser (or interact with a browser) on the client computer 110.

The edit decision list and the media effects set are executed upon the streaming video in real-time. Using the edit decision list, the player 150 generates the title screen and the transition in proper sequence with the streaming incoming video media base data 335. The player 150 pulls the Spanish subtitles, the audio effects, and the ‘black-and-white’ effect from the media effects set 334 and applies such effect at the frames indicated in the edit decision list 336. Thus, the “edited video” created in the editing session by the first user (the editor) is presented to the second user in an online environment in real-time (i.e., the edits are applied as the streaming video arrives and is rendered for the second user) without incurring the storage costs associated with creating a separate stored file of the edited video.

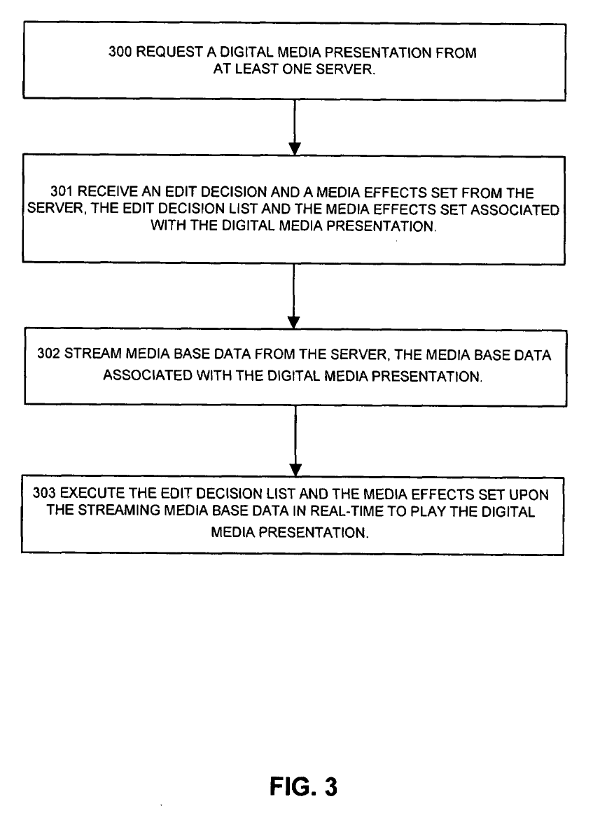

Turning now to FIG. 3, a flow chart of processing steps 300-303 is presented to show high-level processing operations performed by an online media player 150 such as a Flash Player or other rich media player (or video or other media player/editor combination) to execute an edit decision list and a media effects set upon streaming media base data in real-time to play a digital media presentation.

In step 300, the online media player 150 requests a digital media presentation from at least one server 210. For example, a user can click a hyperlink that includes a reference to the digital media presentation. Such a reference can describe an edit decision list 336 and a media effects set 335 to be sent from the server 210 to the user at a client computer 110. In step 301, the online media player 150 receives the edit decision list and the media effects set from the server, the edit decision list and the media effects set associated with the digital media presentation.

In step 302, the online media player 150 streams media base data 335 from the server(s), the media base data 335 associated with the digital media presentation. It is understood that streaming media base data can be media (e.g., video files, audio files, graphics files, still image files) that is continuously received by, and normally displayed to, the end-user whilst it is being delivered by a provider.

In step 303, the online media player 150 executes the edit decision list and the media effects set upon the streaming media base data in real-time to play the digital media presentation. A person having ordinary skill in the art would recognize that real-time can be a level of computer responsiveness that the user senses as sufficiently immediate or that enables the computer to keep in time with some external process, such as media streaming.

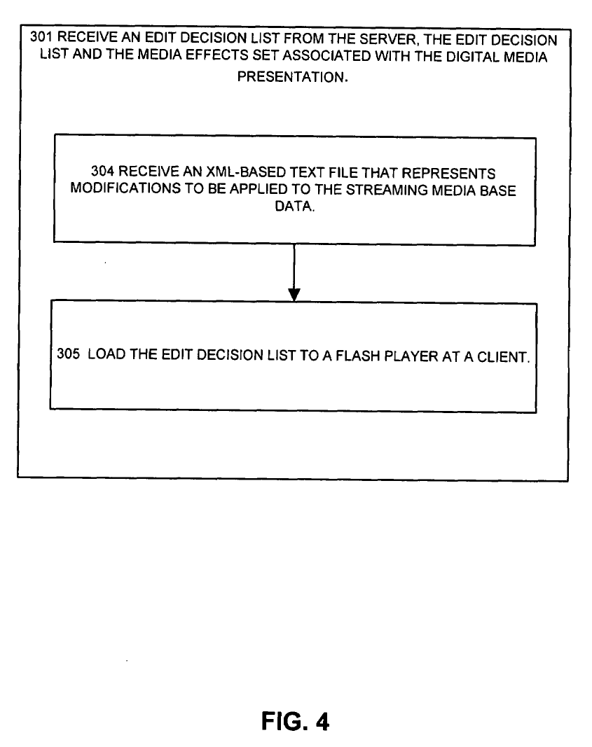

Regarding FIG. 4, a flow chart for processing steps 304-305 shows high-level processing operations performed by an online media player 150 to receive an edit decision list from a server. In step 304, the online media player 150 receives an XML-based text file that represents modifications to be applied to the streaming media base data. The modifications represented in the XML-based text file can be all the edits recorded during a previous editing session made to the media base data. Thus, the XML-based text file can act as an instruction set to mimic or recreate the recorded edits from the previous editing session. In step 305, the online media player 150 loads the edit decision list to a Flash Player at a client. It is understood that the entire edit decision list need not be loaded to the Flash Player. Hence, portions of the edit decision list can be loaded to the Flash Player and other portions of the edit decision list can reside within the client and still interact with the Flash Player or with a browser. The Flash Player is a multimedia and application player created and distributed by Adobe. The Flash Player runs SWF files that can be created by the Adobe Flash authoring tool, Adobe Flex or a number of other Adobe and third party tools. Adobe Flash can refer to both a multimedia authoring program and the Flash Player, written and distributed by Adobe, that uses vector and raster graphics, a native scripting language called ActionScript and bidirectional streaming of video and audio. Adobe Flash can also relate to the authoring environment and Flash Player is the virtual machine used to run the Flash files. Thus, “Flash” can mean either the authoring environment, the player, or the application files. It is also noted that the online media player 150 is not limited to using only a Flash Player.

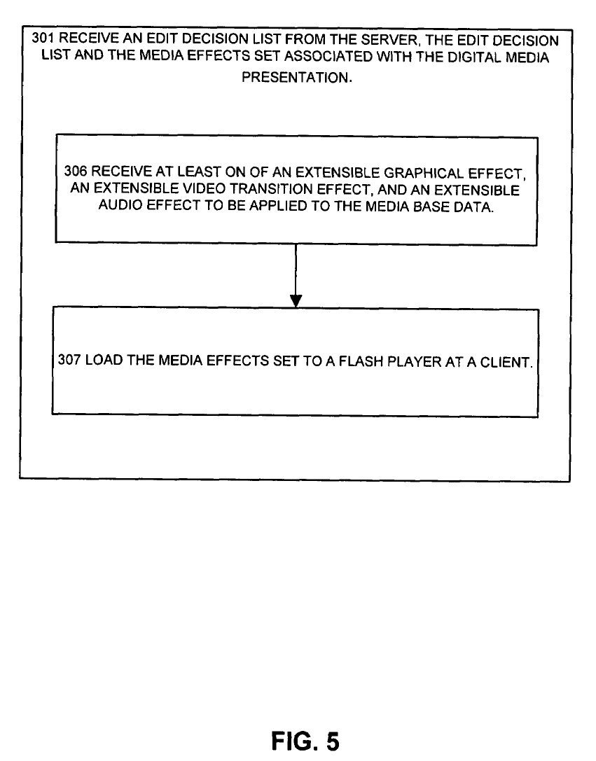

Referring to FIG. 5, a flow chart of processing steps 306-307 shows high-level processing operations performed by an online media player 150 to receive a media effects set from a server. In step 306, the online media player 150 receives at least one of an extensible graphical effect, an extensible video transition effect and an extensible audio effect to be applied to the media base data. A person having ordinary skill in the art would recognize that extensibility is a system design principle where the implementation takes into consideration future modification and enhancement. Extensions can be through the addition of new functionality or through the modification of existing functionality while minimizing the impact to existing system functions. Extensibility can also mean that a system has been so architected that the design includes mechanisms for expanding/enhancing the system with new capabilities without having to make major changes to the system infrastructure. Extensibility can also mean that a software system's behavior is modifiable at runtime, without recompiling or changing the original source code. Thus, an extensible graphical effect from a previous editing session can be automatically updated to a more current version of the graphical effect and included in the media effects set. In step 307, the online media player 150 loads the media effects set to the Flash Player at the client.

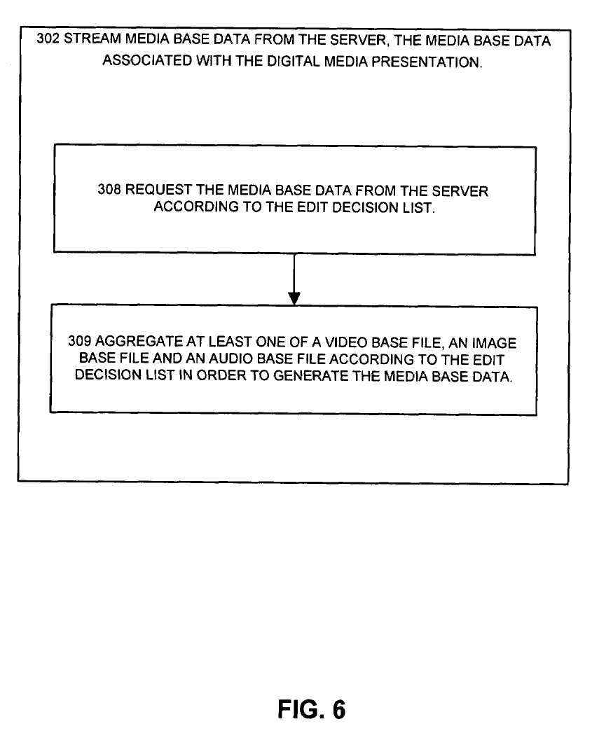

According to FIG. 6, a flow chart of processing steps 308-309 illustrates high-level processing operations performed by an online media player 150 to stream media base data from a server. In step 308, the online media player 150 requests the media base data from the server according to the edit decision list. For example, the edit decision list can send information to the server regarding which files were previously used to make the digital media presentation. In step 309, the online media player 150 aggregates at least one of a video base file, an image base file and an audio base file according to the edit decision list in order to generate the media base data.

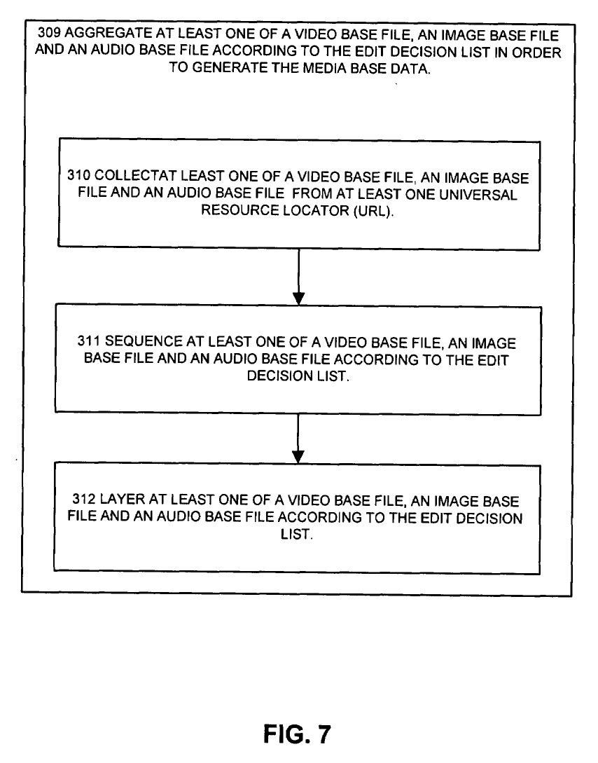

Regarding FIG. 7, a flow chart of processing steps 310-312 shows high-level processing operations performed by an online media player 150 to aggregate at least one of a video base file, a image base file and an audio base file. In step 310, the online media player 150 collects at least one of the video base file, the image base file and the audio base file from at least one universal resource locator (URL). Any URL on the Internet can be used to locate and collect the files. Specifically, the online media player 150 can execute instructions related to the edit decision list from the server to locate media files and media data from any given URL(s) that can be used for the media base data. In the alternative, such files and data can already be stored in a digital library or digital asset management system related to the server. In step 311, the online media player 150 sequences at least one of the video base file, the image base file and the audio base file according to the edit decision list. Thus, the edit decision list can provide the server with information regarding how to order the various video, image, and audio files to make up the media base data. It is also understood that sequencing can include inserting one file at a certain point within another file. In other words, an image file can be sequenced to appear half way into a video file.

In step 312, the online media player 150 layers at least one of the video base file, the image base file and the audio base file according to the edit decision list. Here, rather than simply sequencing files, the edit decision list can provide the server with information regarding how to further place the files in relation to one another. For example, an audio file can be layered over a video file to stream simultaneously for a certain amount of time.

In step 313, the online media player 150 includes a Flash Player that receives the streaming media base data from a Flash Media Server. The Flash Media Server is an enterprise-grade data and media server from Adobe Systems Inc. The Flash Media Server can work together with the Flash Player during runtime and streaming to create media driven, multiuser RIA (Rich Internet Applications).

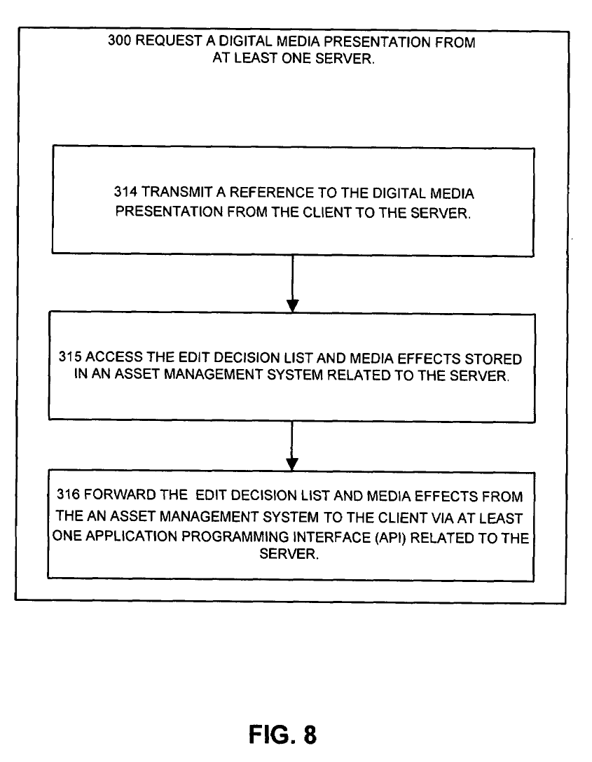

Referring now to FIG. 8, a flow chart of processing steps 314-316 shows high-level processing operations performed by an online media player 150 to request a digital media presentation from a server. In step 314, the online media player 150 transmits a reference to the digital media presentation from the client to the server. In step 315, the online media player 150 accesses the edit decision list and the media effects set stored in an asset management system related to the server. Such an asset management system can be utilized for managing content for the web. The asset management system can manage content (text, graphics, links, etc.) for distribution on a web server. Thus, the asset management system can also include software where users can create, edit, store and manage content with relative ease of use. Such an asset management system can use a database, for example, to hold content, and a presentation layer displays the content to regular website visitors based on a set of templates. In step 316, the online media player 150 forwards the edit decision list and the media effects set from the asset management system to the client via at least one application programming interface (API) related to the server.

Note again that techniques herein are well suited to allow for real-time edit decision list execution on streaming video to play back an edited video in an online environment via an online media player. However, it should be noted that the online media player can be part of a software system that provides edit decision list creation capabilities and can be implemented independently. Further, embodiments herein are not limited to use in such applications and that the techniques discussed herein are well suited for other applications as well.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

What is claimed is:

1. A computer-implemented method, comprising:
requesting a digital media presentation from at least one server;
receiving an edit decision list from the server, the edit decision list associated with the digital media presentation;
receiving streaming media base data from the server, the media base data associated with the digital media presentation; and
applying the edit decision list upon the streaming media base data in real-time to create the digital media presentation.

2. The method as in claim 1, wherein receiving the edit decision list from the server comprises receiving an XML-based text file that represents modifications to be applied to the streaming media base data.

3. The method as in claim 1, wherein receiving the edit decision list from the server comprises loading the edit decision list into a rich media player executing at a client and executing the edit decision list within the rich media player.

4. The method as in claim 1, comprising:
identifying a media effect within the edit decision list that is to be applied to the streaming media base data;
in response, requesting a media effects set containing the media effect from the server;
receiving the media effects set from the server, the media effects set including at least one of an extensible graphical media effect, an extensible video transition media effect and an extensible audio media effect to be applied to the media base data in real-time during execution of the edit decision list upon the streaming media base data.

5. The method as in claim 1, wherein receiving streaming media base data from the server comprises:
requesting the media base data from the server according to the edit decision list; and
aggregating at least one of a video base file, an image base file and a audio base file according to the edit decision list in order to generate the media base data.

6. The method as in claim 5, wherein aggregating at least one of the video base file, the image base file and the audio base file comprises:
collecting at least one of the video base file, the image base file and the audio base file from at least one universal resource locator (URL);
sequencing at least one of the video base file, the image base file and the audio base file according to the edit decision list; and
layering at least one of the video base file, the image base file and the audio base file according to the edit decision list.

7. The method as in claim 1, wherein receiving the streaming media base data from the server comprises executing the rich media player in a client computer system and requesting the streaming media base data from a rich media server over a network.

8. The method as in claim 1, wherein requesting the digital media presentation from the server comprises:
transmitting a reference to the digital media presentation from the client to the server;
accessing the edit decision list and a media effects set stored in an asset management system related to the server; and
forwarding the edit decision list and the media effects set from the asset management system to the client via at least one application programming interface (API) operating between the client and the server.

9. A method comprising:
providing, from a client to a server, a request to play a digital media presentation by the client for viewing by a user;
executing a rich media player to receive an edit decision list, the edit decision list indicating a sequence of base media data and corresponding edits to be applied to the base media data in real-time to render the digital media presentation;
executing the edit decision list within the rich media player, executing the edit decision list comprising:
i) providing at least one request for base media data to a rich media server to allow the rich media server to stream the base media data to the client;
ii) receiving the base media data from the rich media server;
iii) applying edits within the edit decision list in real-time to the base media data to play the digital media presentation by the client for viewing by a user.

10. A computer readable medium comprising executable instructions encoded thereon operable on a computerized device to perform processing comprising:
instructions for requesting a digital media presentation from at least one server;
instructions for receiving an edit decision list from the server, the edit decision list associated with the digital media presentation;
instructions for receiving streaming media base data from the server, the media base data associated with the digital media presentation; and
instructions for applying the edit decision list upon the streaming media base data in real-time to create the digital media presentation.

11. The computer readable medium as in claim 10, wherein the instructions for receiving the edit decision list from the server comprise instructions for receiving an XML-based text file that represents modifications to be applied to the streaming media base data.

12. The computer readable medium as in claim 10, wherein the instructions for receiving an edit decision list from the server comprise instructions for loading the edit decision list into a rich media player executing at a client and executing the edit decision list within the rich media player.

13. The computer readable medium as in claim 10, comprising:
instructions for identifying a media effect within the edit decision list that is to be applied to the streaming media base data;
instructions for requesting a media effects set containing the media effect from the server;
instructions for receiving the media effects set from the server, the media effects set including at least one of an extensible graphical media effect, an extensible video transition media effect and an extensible audio media effect to be applied to the media base data in real-time during execution of the edit decision list upon the streaming media base data.

14. The computer readable medium as in claim 10, wherein the instructions for receiving streaming media base data from the server comprise:
instructions for requesting the media base data from the server according to the edit decision list; and
instructions for aggregating at least one of a video base file, an image base file and a audio base file according to the edit decision list in order to generate the media base data.

15. The computer readable medium as in claim 14, wherein the instructions for aggregating at least one of the video base file, the image base file and the audio base file comprise:
instructions for collecting at least one of the video base file, the image base file and the audio base file from at least one universal resource locator (URL);
instructions for sequencing at least one of the video base file, the image base file and the audio base file according to the edit decision list; and
instructions for layering at least one of the video base file, the image base file and the audio base file according to the edit decision list.

16. The computer readable medium as in claim 10, wherein the instructions for receiving the streaming media base data from the server comprise instructions for executing the rich media player in a client computer system and requesting the streaming media base data from a rich media server over a network.

17. The computer readable medium as in claim 10, wherein the instructions for requesting the digital media presentation from the server comprises:
instructions for transmitting a reference to the digital media presentation from the client to the server;
instructions for accessing the edit decision list and the media effects set stored in an asset management system related to the server; and
instructions for forwarding the edit decision list and the media effects from the asset management system to the client via at least one application programming interface (API) operating between the client and the server.

18. A computerized device comprising:
a memory;
a display;
a processor;
an interconnection mechanism coupling the memory, the display and the processor;
a network connection to at least one server;
wherein the memory is encoded with an online media player application that when executed on the processor provides an online media player process that implements processing on the computerized device;
the online media player requesting a digital media presentation from at least one server;
the online media player receiving an edit decision list from the server, the edit decision list associated with the digital media presentation;
the online media player receiving streaming media base data from the server, the media base data associated with the digital media presentation; and
the online media player applying the edit decision list upon the streaming media base data in real-time to create the digital media presentation.

19. The computerized device as in claim 18, wherein the online media player receiving streaming media base data from the server comprises the online media player requesting at least one of a video base file, an image base file and a audio base file according to the edit decision list in order to generate the streaming media base data from the server.

20. The computerized device as in claim 19, wherein the online media player requesting at least one of a video base file, an image base file and a audio base file according to the edit decision list in order to generate the streaming media base data from the server comprises:
the online media player directing the server to collect at least one of the video base file, the image base file and the audio base file from at least one universal resource locator (URL) according to the edit decision list;
the online media player directing the server to sequence at least one of the video base file, the image base file and the audio base file according to the edit decision list; and
the online media player directing the server to layer at least one of the video base file, the image base file and the audio base file according to the edit decision list.

21. A computer-implemented method, comprising:
receiving a request for a digital media presentation;
transmitting an edit decision list, the edit decision being associated with the digital media presentation;
transmitting streaming media base data, the media base data associated with the digital media presentation; and
the edit decision list being applicable upon the streaming media base data in real-time to create the digital media presentation.
